(19) United States
(12) Patent Application Publication
(10) Pub. No.: US 2005/0254635 A1
(43) Pub. Date: Nov. 17, 2005

(54) Method and apparatus for conveying short messages to PSTN telephone during regular voice communication

(75) Inventors: Victor Koretsky, Raanana (IL); Doron Koren, Netanya (IL)

Correspondence Address: BROWDY AND NEIMARK, P.L.L.C.;624 NINTH STREET, NW, SUITE 300, WASHINGTON, DC, 20001-5303, US

(73) Assignee: D.S.P. Group Ltd., Herzelia Pituach (IL)

(21) Appl. No.: 10/845,145

(22) Filed: May 14, 2004

(51) Int. Cl. H04M 1/56; H04M 3/42; H04M 15/06

(52) U.S. Cl. 379/142.08; 379/215.01

(57) ABSTRACT

A source telephone terminal connected to the PSTN conveys an instant message to a target telephone terminal during voice communication. The source telephone may be equipped with a Central Office Call Waiting Caller ID (COCWCID) protocol emulator for conveying an alert signal to the target telephone terminal to inform the target telephone terminal that the source telephone terminal wishes to convey an instant message; and for conveying the instant message to the target telephone terminal in response to an acknowledge signal received from the target telephone terminal. The target telephone may be a regular telephone having a Customer Premises Equipment CWCID protocol support and may optionally have a COCWCID protocol emulator so that instant messages can be conveyed bi-directionally. In a hybrid telephone network containing PSTN, VoIP and cellular telephones, the telephone terminals may be appropriate gateways equipped with CWCID protocol transmission and reception capability.

### FIELD OF THE INVENTION

This invention relates to sending telephone short messages.

### BACKGROUND OF THE INVENTION

U.S. Pat. No. 6,594,255 (Neuman) issued Jul. 15, 2003 and entitled “PBX with short messaging service on a telephone display” discloses a method and apparatus for sending and displaying short messages from data network users which are linked to a telephonic network. The telephonic network comprises telephones, each with a display for visually displaying short messages to subscribers of the telephonic network. The apparatus holds a dialogue between the data network users and a software agent embedded in the telephonic network. The dialogue provides the telephonic network the content, the sender ID and the address information of each short message, stores the content and address information in a database, and displays the content of the messages on the telephone display of each destined subscriber.

U.S. Pat. No. 6,668,043 (Hyziak, et al.) issued Dec. 23, 2003 and entitled “Systems and methods for transmitting and receiving text data via a communication device” discloses a method of transmitting and receiving text data via a communication device. In one embodiment, an incoming message is received at a communication node. The node determines whether the incoming message comprises text data, and if so, forwards the incoming message to a communication device. If not, the message is forwarded to a text interface.

In another embodiment, an instruction signal is received at a communication node. Based on the instruction signal, a connection is established with a communication device. A text message is then received. The node determines if the device can receive the text-message. If so, the message is forwarded to the device, and if not, it is forwarded to a text interface.

U.S. Pat. No. 6,389,114 (Dowens, et al.) issued May 14, 2002 and entitled “Method and apparatus for relaying communication” discloses a telecommunication relay device that relays communication from a source party to at least one target party. The telecommunication relay device converts text received from text terminals into voice for voice terminals and converts voice to text and vice versa. The telecommunication relay device also permits the target party to leave messages for other parties.

U.S. 20040013242 (Engelke et al.) published Jan. 22, 2004 and entitled “Text enhanced telephony” discloses a system for assisting the hard of hearing in the use of the telephone, the system being coined text enhanced telephony or TET. The hard of hearing user uses a TET device or appliance which permits the user to speak and to hear the words spoken by the other party, the TET device also supplying to the user a text character stream of the words spoken by the other party. The TET system uses the system of voice-to-text relays, already in existence to assist the deaf community communicate with hearing persons over the telephone, to translate the spoken voice into a text stream. The TET relay and TET device are capable of separating voice and digital communications frequencies carrying text so that voice and a text communications stream of the words spoken by the voice can be carried over a common telephone line. The devices can also be capable of automated capabilities such that the devices can automatically configure a three-party relay call without the need for the user's instructions.

U.S. 20030072420 (Feigenbaum) published Apr. 17, 2003 and entitled “System for enabling TDD communication in a telephone network and method for using same” discloses a system and method for enabling telephone network subscribers using a telecommunications device for the deaf (TDD) to communicate with other network subscribers lacking such a device. The TDD user dials a number that connects him with an automatic relay switch (ARS), which determines the intended recipient of the call and establishes a connection thereto. The TDD user then transmits a message in TDD format to the ARS, which converts it into an ASCII text file that is in turn provided to a text-to-speech (TTS) engine that synthesizes a voice message from the text file. The voice message is then sent to the non-TDD-enabled subscriber. The ARS then preferably prompts the non-TDD-enabled subscriber to enter a response. The response may be made by voice communication or by using the telephone keypad to send dual-tone multi-frequency tones back to the ARS according to instructions that were provided to the called party for this purpose.

### SUMMARY OF THE INVENTION

It is an object of the invention to provide a method and improved source telephone terminal for allowing direct communication of instant messages over the PSTN from the source telephone terminal to a target telephone terminal.

This object is realized in accordance with a first aspect of the invention by a method of receiving an instant message at a target telephone terminal during voice communication between a source telephone terminal connected to the Public Switched Telephone Network (PSTN) and the target telephone terminal, the method comprising:
(a) receiving from the source telephone terminal an instant message sent directly to the target telephone terminal by the source telephone terminal; and
(b) displaying the instant message on a display device of the target telephone terminal.

According to a second aspect of the invention there is provided a source telephone terminal, comprising:
a connector for connecting to the PSTN line,
a display device for displaying information, and
a Central Office Call Waiting Caller ID protocol emulation for conveying an alert signal to a target telephone terminal that is in voice communication with the source telephone terminal via the PSTN so as to inform the target telephone terminal that the source telephone terminal wishes to convey an instant message during said voice communication; and for conveying an instant message to the target telephone terminal in response to an acknowledge signal received from the target telephone terminal acknowledging receipt thereby of the alert signal.

Preferably, such a telephone terminal further includes a Customer Premises Equipment Call Waiting Caller ID protocol apparatus for receiving an alert signal from the target telephone terminal informing the source telephone terminal that the target telephone terminal wishes to convey an instant message during said voice communication; for returning an acknowledge signal to the target telephone terminal for acknowledging receipt of the alert signal; for receiving the instant message from the target telephone terminal and for displaying the instant message on the display device

Such a telephone terminal is thus adapted to both send and receive instant messages, such as short text messages and to send instant messages to a regular telephone terminal having a display and Customer Premises Equipment Call Waiting Caller ID reception capability. Uni-directional transfer of instant messages such as textual or graphic information may be effected during a regular voice communication to enhance voice data. For example, it may be used for one party to send another party, information of the kind contained in a business card or other record stored in a phone book. Such information may be stored in a memory of the source telephone terminal and may be selectable during a regular telephone conversation using a suitable selector such as a keypad and the like.

Two enhanced telephone terminals having the ability to both send and receive instant messages may be used to convey instant messages where voice messages are inappropriate, such as between the deaf and/or dumb.

According to such an embodiment, there is provided a method for allowing first and second PSTN telephone subscribers to conduct a “silent” telephone conversation, the method comprising:
(a) providing the first and second subscribers with a respective first and second telephone terminal both being adapted to send and receive instant messages;
(b) the first subscriber sending from the first telephone terminal to the second telephone terminal an instant message for display by the second telephone terminal;
(c) the second subscriber sending from the second telephone terminal to the first telephone terminal an instant message for display by the first telephone terminal; and
(d) repeating (b) and (c) until either one of the subscribers terminates.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1 and 2 show pictorially representations of systems according to alternative embodiments for allowing a PSTN telephone to convey instant messages directly to a source telephone

FIG. 3 is a schematic ‘Call Flow’ diagram showing signaling between two PSTN telephones conveying an instant message using conventional Call Waiting Caller ID protocol;

FIG. 4 is a schematic ‘Call Flow’ diagram showing signaling between two telephones one of which conveys an instant message directly to the other using Call Waiting Caller ID protocol in accordance with a preferred embodiment of the invention;

FIGS. 5a and 5b are flow diagrams showing the principal operations carried out by a target telephone having an automatic answering feature in accordance with an embodiment of the invention;

FIG. 6 is a flow diagram showing the principal operations used to convey long instant messages according to a preferred embodiment of the invention;

FIG. 7 is a flow diagram showing the principal operations used to convey bidirectional instant messages such as between deaf parties; and

FIGS. 8 and 9 are block diagrams showing functionally source telephones adapted to convey direct instant messages according to alternative embodiments.

### DETAILED DESCRIPTION OF EXEMPLARY EMBODIMENTS

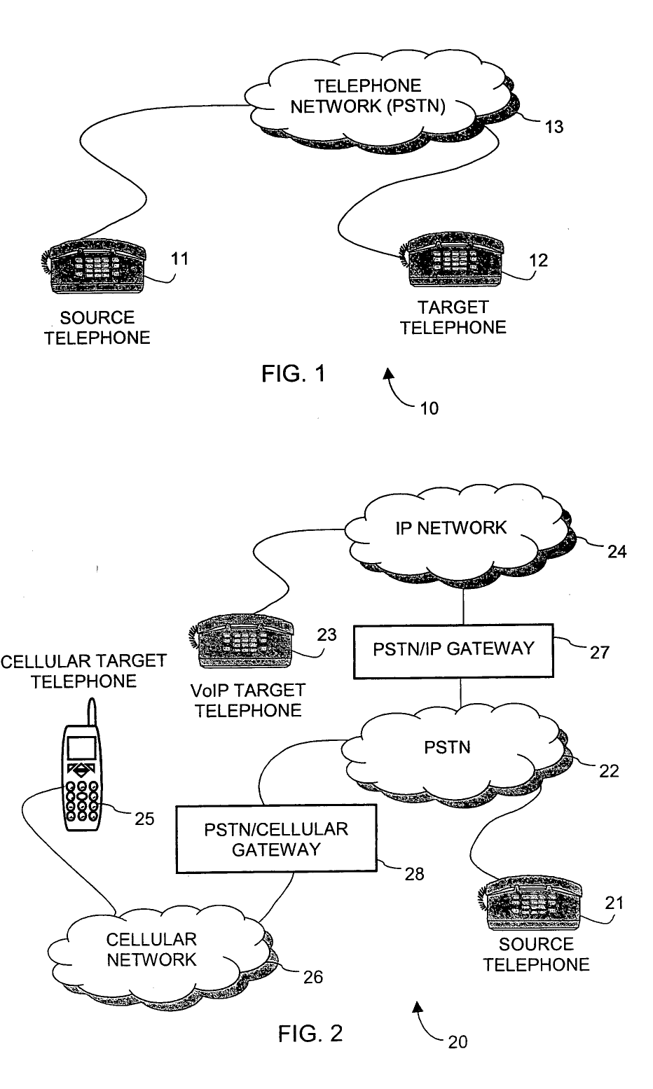

FIG. 1 shows pictorially a system 10 according to one embodiment for conveying instant messages between a source telephone 11 and a target telephone 12 interconnected via a Public Switched Telephone Network (PSTN) 13.

FIG. 2 is a pictorial representation of a hybrid system 20 for conveying instant messages between a source telephone 21 connected to the PSTN 22 and a VoIP target telephone 23 coupled to an IP network 24, as well as a cellular target telephone 25 connected to a cellular network 26. The only substantive difference between the system 10 shown in FIG. 1 and the hybrid system 20 shown in FIG. 2 is that in the system 20 signaling and media are conveyed from one network to the other via a PSTN/IP gateway 27 or PSTN/Cellular gateway 28, which operate in a manner well known in the art to convert the signals between PSTN and IP or PSTN and Cellular protocols and vice versa. As is known, the cellular network 26 is essentially “short message (SMS) enabled” already. The PSTN/IP gateway 27 and the PSTN/Cellular gateway 28 should emulate the Call Waiting Caller ID protocol in respect of the source telephones in the respective networks.

By way of example, so far as the IP network 24 is concerned, the PSTN/IP gateway 27 functions as an intermediate target that receives signaling and media from the source telephone 21. In the IP network 24, the signaling and media are received together by the PSTN/IP gateway 27 on the same path and allow connection to the VoIP target telephone 23. A message conveyed by the source telephone 21 is directed by the PSTN 22 to the PSTN/IP gateway 27, which in turn determines that the required destination is the VoIP target telephone 23 in the IP network 24. The PSTN/IP gateway 27 receives the signaling and media on separate paths in the PSTN 22, performs the required protocol conversion and redirects the signaling and media on a common path in the IP network 24 to the target telephone. The PSTN/IP gateway 27 converts IP network instant messages to the necessary format for PSTN. Similarly, the cellular telephone 25 may send SMS messages directly to the telephone 21 via the PSTN/Cellular gateway 28, which is adapted to emulate PSTN Central Office Call Waiting Caller ID protocol. When the message reaches the PSTN/Cellular gateway 28, the latter determines that the destination address is a telephone in either the PSTN 22 or in the IP network 24 and processes the short message as will be explained below with particular reference to FIG. 4. Thus, the invention allows SMS from the cellular network or instant messages from the IP network to be sent to a PSTN telephone having Call Waiting Caller ID support.

Short Message Service, or SMS, originally developed for GSM mobile communication in Europe, was later extended to PSTN telephony in Europe and won great success among mobile service subscribers. A distinctive feature of this service is the requirement of a service provider, who delivers the messages from a calling party to a called party for a fee.

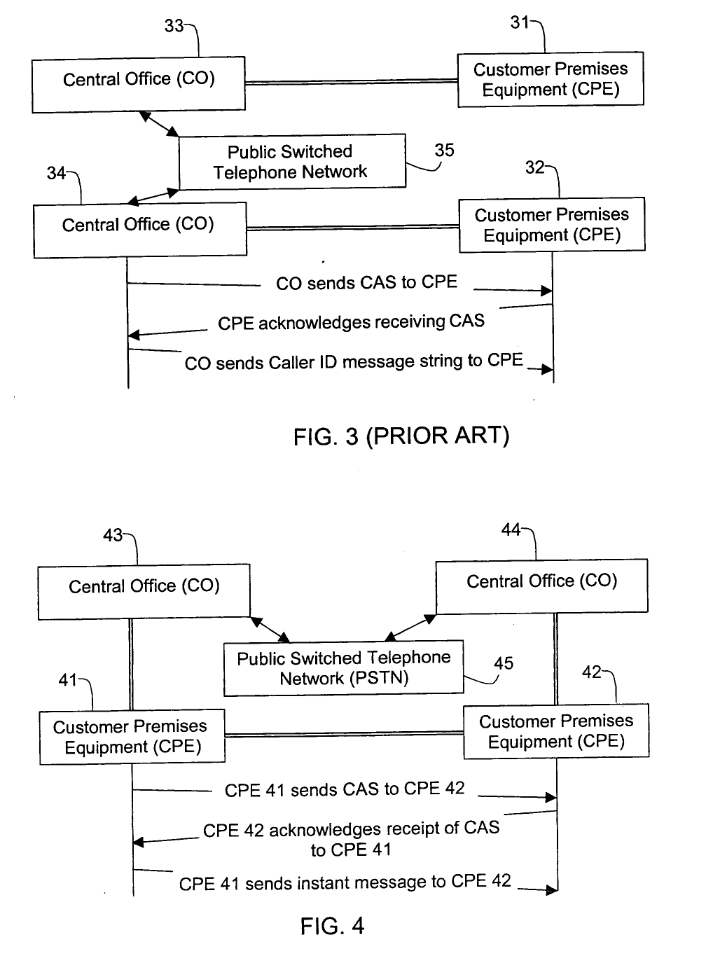

FIG. 3 is a schematic ‘Call Flow’ diagram showing signaling between two PSTN telephones conveying an instant message using conventional Call Waiting Caller ID protocol. The Call Waiting Caller ID transmission protocol requires two parties, a Central Office (CO) and Customer Premises Equipment (CPE), also known as a Telephone Terminal or simply Telephone. CPEs 31 and 32 are interconnected via respective COs 33 and 34 switched via the PSTN 35, thereby allowing regular voice communication between first and second parties operating the CPEs 31 and 32, respectively. If a third party calls the second party CPE 32 during this call, the respective CO 34 disconnects the voice path from CPE 31 to CPE 32 and sends a so-called CPE Alert Signal (CAS) to the CPE 32. CPE 32, upon receiving the CAS, acknowledges receipt to CO 34 and prepares to receive the Caller ID message string. CO 34, upon receiving the acknowledge signal from CPE 32, sends Caller ID message string, to CPE 32. Upon receiving this message, CPE 32 displays it allowing the second party to accept or reject the third party's call. In order for such a scheme to operate the CPE 32 (constituting a “target telephone”) must be equipped to recognize Customer Premises Equipment Call Waiting Caller ID protocol. This is fast becoming an accepted feature of most regular PSTN telephones now being sold. Call Waiting Caller ID protocol has been widely deployed during last years and tens of millions of PSTN telephone terminals supporting it have been sold and are working in consumer possession.

FIG. 4 is a schematic ‘Call Flow’ diagram showing signaling between two telephones one of which conveys an instant message directly to the other using Call Waiting Caller ID protocol in accordance with a preferred embodiment of the invention. A CPE 41 constituting a source telephone and CPE 42 constituting a target telephone are interconnected via respective COs 43 and 44 switched via the PSTN 45, thereby allowing regular voice communication between a calling party and a called party operating the CPEs 41 and 42, respectively.

The essence of the invention is the addition to the source telephone 41 of CO Call Waiting Caller ID protocol emulation, in order for it to be able to send Caller ID message string with any content directly from the source telephone 41 to the target telephone 42 during an established phone call conversation. Again, the target telephone 42 must be equipped to recognize Customer Premises Equipment Call Waiting Caller ID protocol, but as noted above this is currently being offered as a standard feature on most new PSTN telephone equipment.

As seen in FIG. 4, the source telephone 41 sends a CAS (constituting an “alert signal”) directly to the target telephone 42, without requiring that the CAS be sent first to the CO 43 as is required in conventional the call waiting protocol depicted in FIG. 3. This is made possible by providing CO Call Waiting Caller ID protocol emulation within the source telephone 41 so that, providing that the target telephone 42 is equipped to recognize Customer Premises Equipment Call Waiting Caller ID protocol, instant messages can be sent directly from the source telephone 41 to the target telephone 42. Preferably the source telephone 41 is also equipped to recognize Customer Premises Equipment Call Waiting Caller ID protocol so that, if the target telephone 42 is equipped to convey an instant message to the source telephone 41, the latter will be able to process it. By such means, both telephones can convey to each instant messages either during regular voice communication or even instead of it.

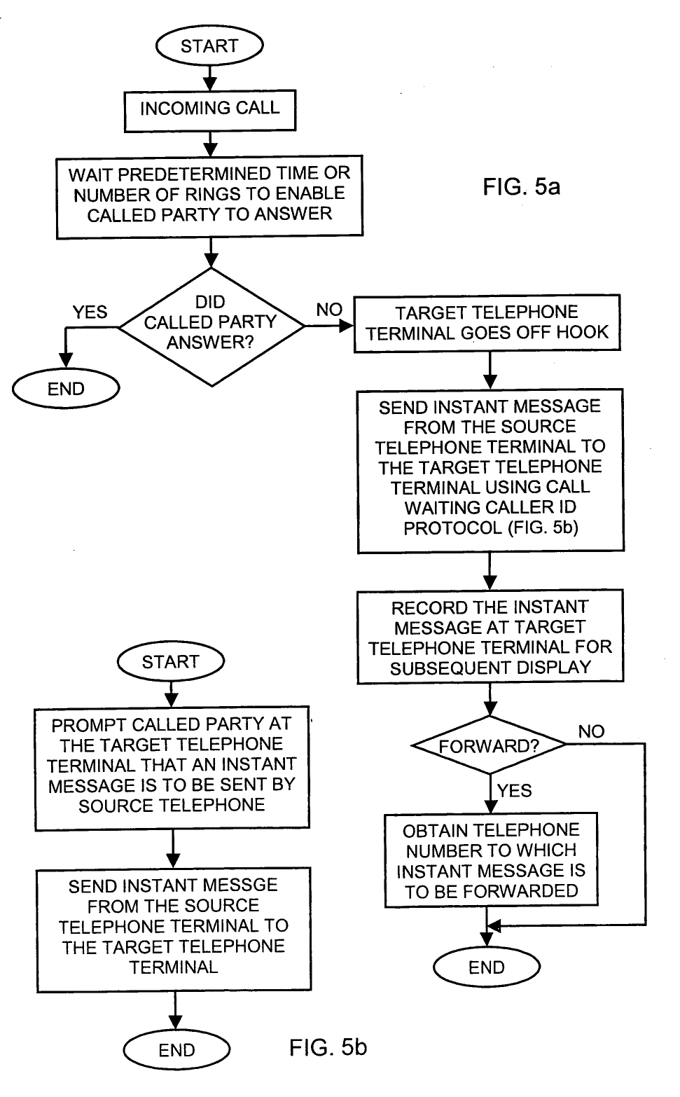

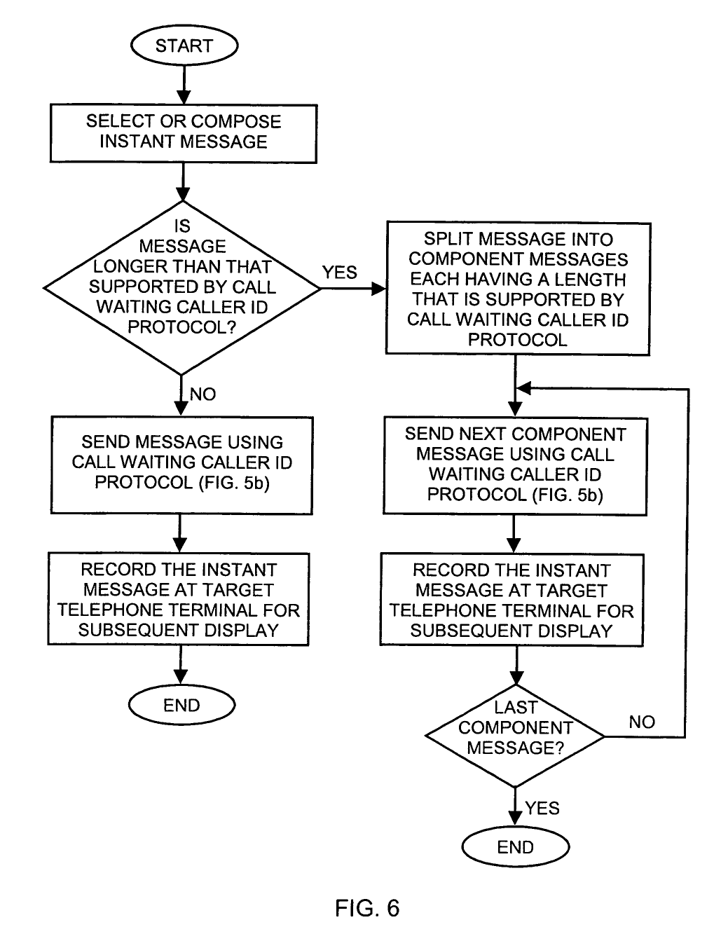

FIGS. 5a and 5b are flow diagrams showing the principal operations carried out by a target telephone 42 having an automatic answering feature on receipt of instant messages according to an embodiment of the invention. Thus, if the target telephone 42 does not answer within a predetermined time or number of rings, the target telephone 42 automatically goes off-hook and voice prompts the calling party at the source telephone 41 to leave a message. The source telephone 41 now sends an instant message, instead of leaving voice mail as is done conventionally, to the target telephone 42. Preferably, this is done using the Call Waiting Caller ID protocol as shown schematically in FIG. 5b and as described above with reference to FIG. 4 of the drawings. The incoming instant message may be displayed at the target telephone 42 and/or recorded in a Caller ID log stored in a memory thereof for subsequent display.

The instant message received from the source telephone 41 may include data indicative of a telephone number associated with a calling party at the source telephone terminal. In this case, the target telephone 42 may be adapted to store data in a Caller ID log and to dial number automatically. Likewise, the target telephone 42 may be adapted automatically to dial a predetermined telephone number of a different telephone stored in memory so as to forward the stored instant message thereto, thus providing a “follow me” type of facility. In addition to or instead of the stored message, there may be forwarded information associated therewith such as arrival time and date of the stored message.

According to an alternative embodiment, the target telephone 42 may lack the automatic answering facility as described above, but be adapted to respond automatically to an incoming call from the source telephone by sending an instant message to the source telephone. Thus, in this case no voice prompt is communicated by the target telephone 42, which instead sends a CPE alert signal to the source telephone 41. The source telephone 41 acknowledges the alert signal to the target telephone 42, which responds by sending a pre-composed instant message to the source telephone 41.

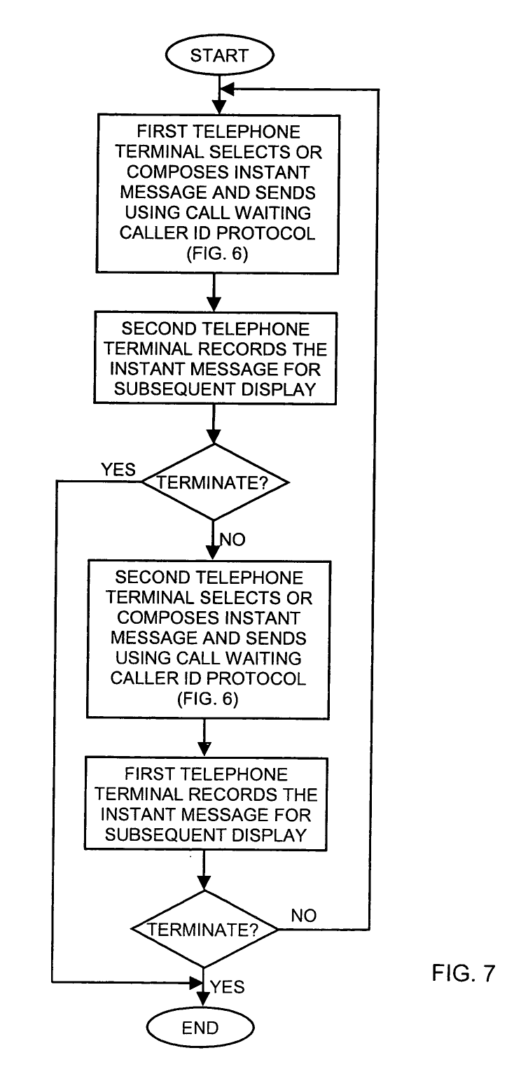

FIG. 6 is a flow diagram showing the principal operations used to convey long instant messages according to a preferred embodiment of the invention. Thus, a message whose length is supported by Call Waiting Caller ID protocol is conveyed in the usual manner as explained above with reference to FIGS. 4 and 5b. However, a message that is too long to be supported by Call Waiting Caller ID protocol is split into multiple component messages, each of which is of a length that is supported by Call Waiting Caller ID protocol. The component messages are then conveyed successively.

FIG. 7 is a flow diagram showing the principal operations used to convey bidirectional instant messages such as between deaf parties or where it is desired to hold “silent” telephone communication between parties so as, for example, not to disturb people nearby. In this case, both parties must be provided with telephones that are equipped with CO Call Waiting Caller ID protocol and recognize Customer Premises Equipment Call Waiting Caller ID protocol. Thus, a first telephone selects or composes an instant message and sends it to the second telephone using Call Waiting Caller ID protocol as described above with reference to FIG. 6. The second telephone receives the instant message and records it for immediate and/or subsequent display. At any stage either of the first or second telephones can terminate the connection. Alternatively, on receipt and display of an instant message, the party at the second telephone may choose to respond. In this case, he also selects or composes an instant message and sends it to the first telephone using Call Waiting Caller ID protocol. The first telephone receives the instant message and records it for immediate and/or subsequent display and the process repeats for as long as both parties require.

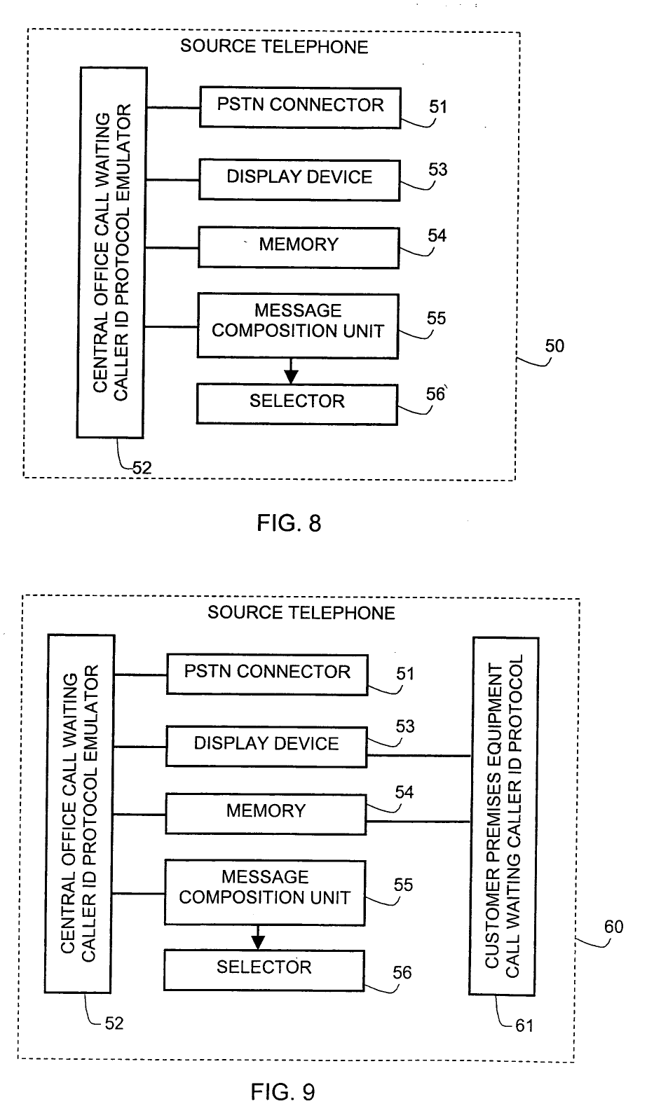

FIG. 8 is a block diagram showing functionally a source telephone 50 adapted to convey direct instant messages according to one embodiment of the invention. The source telephone 50 includes a PSTN connector 51 for connecting to the PSTN and a Central Office Call Waiting Caller ID protocol emulator 52 for conveying an alert signal to a target telephone as described above with reference to FIG. 4, and for conveying an instant message to the target telephone in response to an acknowledge signal received from the target telephone acknowledging receipt thereby of the alert signal. A display device 53 may be provided for displaying information. If the source telephone 50 is not intended to receive instant messages, the display device 53 is optional albeit highly desirable in order to facilitate message selection and/or composition. In the case that the source telephone 50 is also intended to receive and display instant messages, the display device 53 is essential.

A memory 54 may be provided for storing a plurality of pre-composed instant messages; and a selector 55 allows selection of one of the stored instant messages for conveying to the target telephone terminal. A message composition unit 55 allows instant messages to be composed in real time during communication with the target telephone terminal. At its most basic, the message composition unit 55 may be a keypad allowing alphanumeric messages to be composed similar to the formulation of SMS messages in cellular telephones. Likewise, the selector 55 may be a pair of pre-programmed keys allowing scrolling of the messages stored in the memory 54 or may be implemented by a special function key followed by a standard number key.

FIG. 9 is a block diagram showing functionally a source telephone 60 adapted not only to send instant messages but also to receive and display them. Most of the components are identical to those described above with reference to the telephone 50 shown in FIG. 8 and are identified by identical reference numerals. However, in this case, there is further provided a Customer Premises Equipment Call Waiting Caller ID protocol emulator 61 coupled to the display device 53 and to the memory 54 for receiving an alert signal from a target telephone terminal informing the source telephone terminal that the target telephone terminal wishes to convey an instant message during voice communication. The Customer Premises Equipment Call Waiting Caller ID protocol emulator 61 returns an acknowledge signal to the target telephone terminal for acknowledging receipt of the alert signal; for receiving the instant message from the target telephone terminal and for displaying the instant message on the display device 53 and optionally for storing in the memory 54.

It will be appreciated that modifications may be made to the preferred embodiments as described above without departing from the scope of the invention as defined by the accompanying claims. Thus, while in the preferred embodiment the instant messages are text, they may also be pictures, icons, video and multimedia or any suitable combination thereof and may be processed in similar manner to the handling of SMS and MMS in mobile communication.

It will also be understood that the PSTN/IP gateway 27 or the PSTN/Cellular gateway 28 may be suitably programmed computers. Likewise, the invention contemplates a computer program being readable by a computer for executing the method of the invention. The invention further contemplates a machine-readable memory tangibly embodying a program of instructions executable by the machine for executing the method of the invention. Furthermore, the VoIP telephone 23 connected to the IP network 24 may be a suitably programmed computer with a VoIP telephone program running on it.

Finally, it will be appreciated that the since the gateways serve as intermediaries when conveying instant messages from a source telephone in the PSTN to a target telephone in a different type of network, the respective gateways must also be capable of receiving an instant message from a source telephone in one network and transmitting it to a target telephone in a different network.

Thus, the invention also contemplates an IP/PSTN gateway equipped with Call Waiting Caller ID protocol transmission and reception capability; as well as a Cellular/PSTN gateway equipped with Call Waiting Caller ID protocol transmission and reception capability. Furthermore, the respective gateways must be able to do everything that the source telephone can do in order to forward an instant message from the source telephone in one network to a target telephone in another network. Therefore, in the attached claims all references to “source telephone terminal” apply equally to a source telephone as well as to the IP/PSTN gateway and the Cellular/PSTN gateway.

1. A method of receiving an instant message at a target telephone terminal during voice communication between a source telephone terminal connected to the Public Switched Telephone Network (PSTN) and a target telephone terminal, the method comprising:
(a) receiving from the source telephone terminal an instant message sent directly to the target telephone terminal by the source telephone terminal; and
(b) displaying the instant message on a display device of the target telephone terminal.

2. The method according to claim 1, further including:
(c) storing a received message in Caller ID log file of the target telephone terminal for later retrieval

3. The method according to claim 1, wherein prior to receiving the instant message there are further included:
(d) receiving an alert signal from the source telephone terminal informing the target telephone terminal that the source telephone terminal wishes to convey an instant message during said voice communication; and
(e) returning an acknowledge signal to the source telephone terminal for acknowledging receipt of the alert signal.

4. The method according to claim 1, wherein the target telephone terminal is a regular telephone equipped with Customer Premises Call Waiting Caller ID protocol receiving capability, thereby allowing the target telephone terminal to receive instant messages conveyed thereto by the source telephone terminal.

5. The method according to claim 1, wherein the target telephone terminal is a regular telephone equipped with automatic telephone answering feature and Call Waiting Caller ID protocol receiving capability and there are further included:
(f) determining that an incoming call has not been answered within a predetermined time or number of rings;
(g) going off-hook after said predetermined time or number of rings;
(h) receiving the instant message from the source telephone terminal; and
(i) recording the instant message for subsequent display.

6. The method according to claim 1, wherein the target telephone terminal is adapted to receive instant messages automatically and there are further included:
(f) determining that an outgoing call has not been answered within a predetermined time or number of rings;
(g) prompting a party at the source telephone terminal to send an instant message;
(h) receiving the instant message from the source telephone terminal; and
(i) recording the instant message for subsequent display.

7. The method according to claim 5, wherein the target telephone terminal is adapted to respond automatically to the instant message received from the source telephone.

8. The method according to claim 6, wherein the target telephone terminal is adapted to respond automatically to the instant message received from the source telephone.

9. The method according to claim 5, wherein the target telephone terminal is adapted to respond automatically to an incoming call from the source telephone by sending an instant message to the source telephone.

10. The method according to claim 6, wherein the target telephone terminal is adapted to respond automatically to an incoming call from the source telephone by sending an instant message to the source telephone.

11. The method according to claim 7, wherein the instant message received from the source telephone includes data indicative of a telephone number associated with a calling party at the source telephone terminal and the target telephone terminal is adapted to store said data in a Caller ID log and to dial said number automatically.

12. The method according to claim 7, wherein the target telephone terminal is adapted to store the instant message in a Caller ID log and automatically to dial a predetermined telephone number of a different telephone so as to forward the stored instant message and/or information associated therewith thereto.

13. The method according to claim 1 wherein both the source telephone terminal and the target telephone terminal are configured to emulate Central Office Call Waiting Caller ID capability, so as to allow bi-directional exchange of instant messages between the source telephone terminal and the target telephone terminal.

14. The method according to claim 1, wherein the instant message is selected from a pre-stored menu of instant messages.

15. The method according to claim 14, wherein the instant message is selected by pressing special function key followed by a standard number key.

16. The method according to any one of claims 1, wherein the instant message is composed during said voice communication.

17. The method according to claim 1, wherein the instant messages include at least one from the group: text, pictures, emotional icons, video and multimedia.

18. A method for allowing first and second PSTN telephone subscribers to conduct a “silent” telephone conversation, the method comprising:
(a) providing the first and second subscribers with a respective first and second telephone terminal both being adapted to send and receive instant messages;
(b) the first subscriber sending from the first telephone terminal to the second telephone terminal an instant message for display by the second telephone terminal;
(c) the second subscriber sending from the second telephone terminal to the first telephone terminal an instant message for display by the first telephone terminal; and
(d) repeating (b) and (c) until either one of the subscribers terminates.

19. The method according to claim 18, wherein the instant messages include at least one from the group: text, pictures, icons, video and multimedia.

20. The method according to claim 18, wherein both the first telephone terminal and the second telephone terminal are configured to emulate Central Office Call Waiting Caller ID protocol.

21. The method according to claim 1, wherein a length of the instant message is longer than supported by Central Office Call Waiting Caller ID protocol, including splitting it into smaller component messages and conveying said component messages successively.

22. The method according to claim 1, wherein the instant message is a phone book entry.

23. A source telephone terminal, comprising:
a connector for connecting to the PSTN, and
a Central Office Call Waiting Caller ID protocol emulator for conveying an alert signal to a target telephone terminal that is in voice communication with the telephone terminal via the PSTN so as inform the target telephone terminal that the source telephone terminal wishes to convey an instant message during said voice communication; and for conveying an instant message to the target telephone terminal in response to an acknowledge signal received from the target telephone terminal acknowledging receipt thereby of the alert signal.

24. The source telephone terminal according to claim 23, further including:
a memory for storing a plurality of pre-composed instant messages; and
a selector for selecting one of said pre-composed instant messages for conveying to the target telephone terminal.

25. The source telephone terminal according to claim 23, further including:
a message composition unit for composing the instant message in real time during communication with the target telephone terminal.

26. The source telephone terminal according to claim 23, further including:
a display device for displaying information, and
a Customer Premises Equipment Call Waiting Caller ID protocol support for receiving an alert signal from the target telephone terminal informing the source telephone terminal that the target telephone terminal wishes to convey an instant message during said voice communication; for returning an acknowledge signal to the target telephone terminal for acknowledging receipt of the alert signal; for receiving the instant message from the target telephone terminal and for displaying the instant message on the display device.

27. The source telephone terminal according to claim 23, further comprising a memory configured for storing a received instant message.

28. A Central Office Call Waiting Caller ID protocol emulator for coupling to a source telephone terminal having a display device and a connector for connecting to the PSTN, so as to permit said telephone terminal to convey an alert signal to a target telephone terminal that is in voice communication with the telephone terminal via the PSTN so as inform the target telephone terminal that the source telephone terminal wishes to convey an instant message during said voice communication; and for conveying an instant message to the target telephone terminal in response to an acknowledge signal received from the target telephone terminal acknowledging receipt thereby of the alert signal.

29. A telephone system comprising a source telephone coupled to a target telephone terminal via the PSTN, wherein the source telephone terminal comprises:
a connector for connecting to the PSTN, and
a Central Office Call Waiting Caller ID protocol emulator for conveying an alert signal to a target telephone terminal that is in voice communication with the telephone terminal via the PSTN so as inform the target telephone terminal that the source telephone terminal wishes to convey an instant message during said voice communication; and for conveying an instant message to the target telephone terminal in response to an acknowledge signal received from the target telephone terminal acknowledging receipt thereby of the alert signal.

30. The telephone system according to claim 29, wherein the target telephone terminal is a regular PSTN telephone equipped to support Customer Premises Equipment Call Waiting Caller ID protocol.

31. The telephone system according to claim 29, wherein the target telephone terminal is a VoIP telephone or a cellular telephone coupled to the PSTN via a respective gateway that is equipped with Call Waiting Caller ID protocol emulation.

32. An IP/PSTN gateway equipped with Call Waiting Caller ID protocol transmission and reception capability.

33. A Cellular/PSTN gateway equipped with Call Waiting Caller ID protocol transmission and reception capability.
